(19) United States
(12) Patent Application Publication
(10) Pub. No.: US 2002/0004690 A1
(43) Pub. Date: Jan. 10, 2002

(54) Vending machine

(76) Inventors: Jeno F. Paulucci, Duluth, MN (US); Daniel D. Kozlak, Evanston, IL (US); Joel C. Kozlak, Duluth, MN (US)

Correspondence Address: DEVAN V. PADMANAABHAN, Dorsey & Whitney LLP, 220 South Sixth Street, Minneapolis, MN, 55402-1498, US

(21) Appl. No.: 09/842,388

(22) Filed: Apr. 25, 2001

Related U.S. Application Data
(63) Continuation of application No. PCT/US00/28121, filed on Oct. 11, 2000.
(60) Provisional application No. 60/167,813, filed on Nov. 29, 1999.
(60) Provisional application No. 60/158,782, filed on Oct. 12, 1999.

(51) Int. Cl. G06F 19/00

(52) U.S. Cl. 700/237

(57) ABSTRACT

The present invention involves various combinations of new and existing technology to create vending machines with a number of improvements such as, credit and debit card verification in real-time, the incorporation of CDPD technology, multiple vends per one payment, vending of large products, bag dispensing, and the incorporation of microwaves into vending machines.

### TECHNICAL FIELD

The present invention generally relates to vending machines and payment mechanisms used in vending machines.

### BACKGROUND

Vending machines have been around for many years. In the past, vending machines accepted coin money and/or paper money as payment before providing a person with a selected item. Recently, vending machines have incorporated automated technology to process credit and debit card transactions. While this has provided an added convenience to the customer, these machines have been limited to selective real-time processing due to cost considerations. In these machines, validation is only conducted in real-time if the card used by the customer has not previously been used in the machine in a predetermined time period, or if the transaction is above a predetermined amount. Further, systems such as that disclosed in U.S. Pat. No. 5,285,382 to Muehlberger rely on local validation, which includes memory storage of a previously validated card during a predetermined period, as well as rejection of previously invalidated cards during another predetermined period. The disadvantage of a system that does not validate in real-time each time a card is used is that the risk of vending a product in error is greatly increased due to increased credit risk. This risk of error poses a significant problem in vending machines where a large number of transactions are conducted per day.

Clearly, a vending machine with credit card and/or debit card technology that quickly validates in real-time with each transaction without being cost prohibitive to vending machine operators, would be highly desirable.

Further, existing vending machines having some type of credit or debit card technology have incorporated this technology in conjunction with cash payment technology. Because these machines also have cash payment technology, these machines incur significant traditional operating costs. For instance, operators of this type of vending machine incur high security costs because of the vandalism associated with machines having cash-based technology. Further, these machines have high labor costs because the cash reserves must be collected, counted, and supplemented when necessary in order to ensure that the machines carry enough change for customers using cash to pay for items. Further, a great deal of labor time is expended insuring that skimming does not occur in the process of cash collection. A number of personnel must be involved in the process to ensure that sufficient checks are in place such that no one person may skim cash from a machine without having other personnel involved in the process being aware of the inconsistency.

Clearly, it would be desirable to greatly reduce these operating costs by the introduction of cashless vending machines.

Also, in existing vending machine systems, one item is dispensed for each transaction. That is, these machines provide one item per payment. The vending machine operator incurs transaction costs for each transaction. Thus, in existing systems, vending machine operators incur multiple transaction costs for customers who select more than one item for purchase. Further, making multiple payments inconveniences the customer.

Clearly, a payment system that allows for multiple selected vends for one payment would be desirable.

Currently, vending machines that dispense non-beverage items, such as food products, are designed to dispense small items (i.e., items of 12 ounces or less). These vending machines are ill-equipped to vend larger items. One reason that current vending machines are ill-equipped to vend larger items is that the landing area within the vending machine cannot withstand the force caused by the impact of a larger item as it lands on the landing area; and/or the larger non-beverage item is damaged upon impacting the landing area.

However, there is a need for a vending machine that effectively dispenses larger non-beverage items without damaging the items or the machine. For instance, meal items (e.g., dinner entrees) are generally 16 ounces or greater. Currently, if a customer wants to pick up a frozen family style dinner after work—which is greater than 16 ounces—for feeding his/her family, then the customer must stop at a store to pick it up. This additional time-consuming stop inconveniences the customer.

Clearly, there is a need for a vending machine that effectively dispenses larger non-beverage items. This type of vending machine would provide a customer with the meal products he/she would desire from a small store, without the inconvenience of having to purchase them there. Placed at the most convenient locations for customers, a vending machine of the present invention would provide a significant time-saving service.

### SUMMARY

The present invention involves various combinations of new and existing technology to create vending machines with a number of improvements such as, credit card, debit card, and swipe card verification in real-time, the incorporation of wireless CDPD technology, multiple vends per one payment, vending of large products, vending of frozen products, and the incorporation of microwaves into vending machines.

For example, a first embodiment of the present invention relates to a vending machine that comprises a card payment mechanism that obtains real-time validation for each credit or debit card transaction regardless of the amount of payment or whether the card has been used previously in the system. The card payment system may include a card acceptor and a processor that includes a credit verification module. The credit verification module in conjunction with a communications unit may be adapted to communicate with a credit verification facility to obtain verification, which includes validation and authorization for the amount of a purchase. This communication may be done via land lines or by wireless systems, such as systems using CDPD wireless technology.

A second embodiment of the present invention comprises a vending machine with a card payment mechanism in which the vending machine may provide two or more vends for each payment transaction. The second embodiment of the present invention may comprise two or more vending machines controlled by a terminal comprising a processor, a display operably connected to the processor, and software operable on the processor. The software enables multiple vends from the two or more machines in exchange for one payment to cover the cost of all products vended.

A third embodiment of the present invention comprises a vending machine for dispensing large products (i.e., approximately or greater than 16 ounces). This vending machine enables vending machine operators to provide customers with meal solutions traditionally available only in stores. Further, the vending machine operators may place these machines in places that are convenient to customers yet not practicable locations for traditional store owners to place stores.

A fourth embodiment of the present invention comprises a cashless vending machine. This cashless embodiment allows vending machine operators to reduce a number of significant operating costs.

A fifth embodiment of the present invention involves the incorporation of a bag dispenser into a cashless vending machine. This bag dispenser affords customers a convenient way to transport purchased products.

A sixth embodiment of the present invention involves the incorporation of microwave units into vending machines that store frozen products, such that the products may be heated in the microwave units prior to consumption.

Systems with the ability to incorporate the technology of the aforementioned embodiments either alone or in combination, i.e. accepting payment by methods other than coin money or paper money, accepting one payment for multiple purchases by methods other than coin money or paper money, dispensing large products, and dispensing bags to carry the products, are able to vend a wide range of products. For example, such systems may vend any type of meal solution food product, such as, but not limited to, frozen food, refrigerated food, and shelf-stabled food, such as cans or boxes of product, etc. and may vend a convenient bag in which the customer may carry the products purchased. Such systems provide customers with a way to conveniently purchase a wide variety of products without having to wait in line at a store or having to worry about arriving at a store during store hours.

### DESCRIPTION OF THE FIGURES

FIG. 1 shows a vending machine of the present invention that is adapted to dispense large products.

FIG. 2A shows a side view of one embodiment of the driven gears and the idler gears of the vend mechanism.

FIG. 2B shows a front view of one embodiment of the driver gears and the idler gears of the vend mechanism.

FIG. 3A shows a front view of a control panel.

FIG. 3B shows a side view of a control panel.

FIG. 4A shows a front view of a control panel for a vending machine embodiment with a cashless payment system.

FIG. 4B shows a side view of a control panel for a vending machine embodiment with a cashless payment system.

FIG. 5 is a block diagram illustrating the relationship between a processor, selection mechanism, vend mechanism, payment mechanism, and communications unit.

FIG. 6 is a flowchart of acts performed to enable use of credit cards (and debit cards) in vending machines.

FIG. 7 shows a dual vending machine configuration with a credit payment system.

FIG. 8 shows a vending machine that directly incorporates two microwaves into the vending machine.

### DETAILED DESCRIPTION

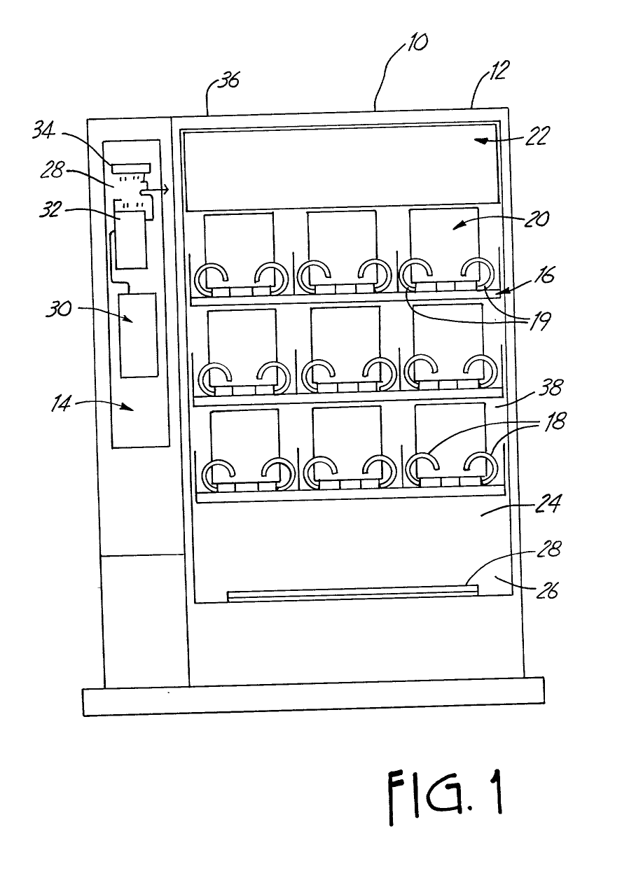

FIG. 1 shows one embodiment of the present invention. FIG. 1 shows a vending machine 10 that includes a product dispensing unit 12 and a control panel 14. The embodiment shown in FIG. 1 has a housing 36 with a clear panel 38 that allows a customer to see the products 20 for sale. The vending machine 10 shown in FIG. 1 may be used to vend large products.

### Product Dispensing Unit

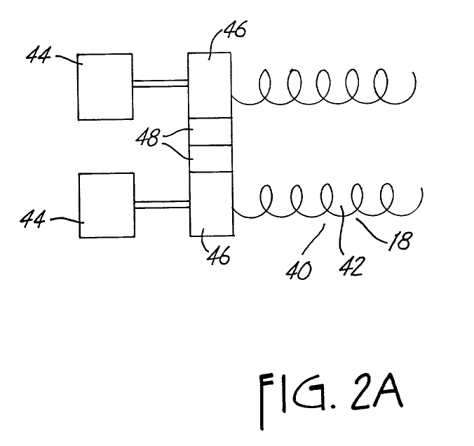

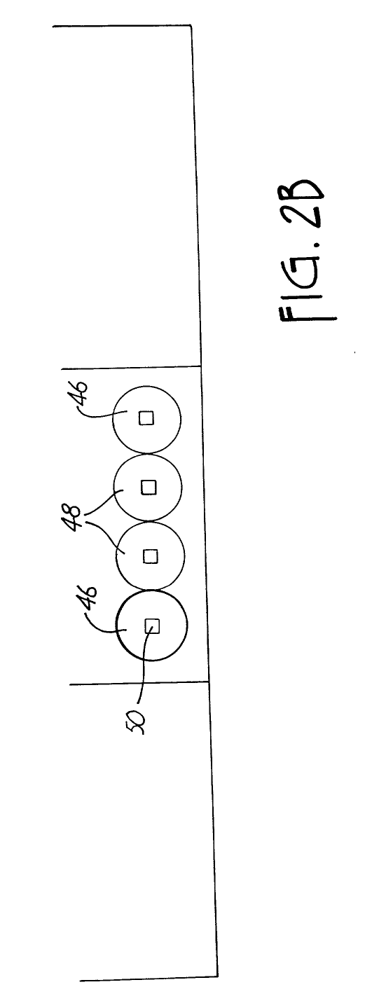

With reference to FIGS. 1, 2A, and 2B, the product dispensing unit 12 will be described. As shown in FIG. 1, the product dispensing unit 12 may include a plurality of vend trays 16 with each vend tray having several vend helixes or vend coils 18 that hold product 20, a first storage compartment 22, a second storage compartment 24, a vend mechanism 72, and a delivery bin 26 with a cushioned pad 28.

Vend Trays

Vending machine 10 may have one or more vend trays 16. Each vend tray 16 may have coils to vend one or more products. In the embodiment shown in FIG. 1, each vend tray 16 is designed to vend three products 20. Vend trays 16 are slidably connected to the housing. That is, the vend trays 16 may be pulled out of the housing to make loading it with product more convenient. Vend trays 16 are known to those skilled in the art.

Vend Coils

As more clearly shown in FIG. 2A, each vend helix 18 is in a generally spiral form. That is, each vend helix 18 is a coil that forms a generally cylindrical shape. Each vend helix 18 comprises a plurality of windings 40. The space between each of a pair of windings 40 forms a compartment 42 for holding a product 20. As shown in FIG. 1, each product 20 is held by a dual helix 19. That is, two vend helixes 18 form a dual helix, whereby compartment 42 of both helixes is used to hold a product 20. This configuration may be used to vend large products (i.e., approximately or greater than 16 ounces). Vend helixes or vend coils 18 are known to those of ordinary skill in this art.

Dispensing or Vend Mechanism

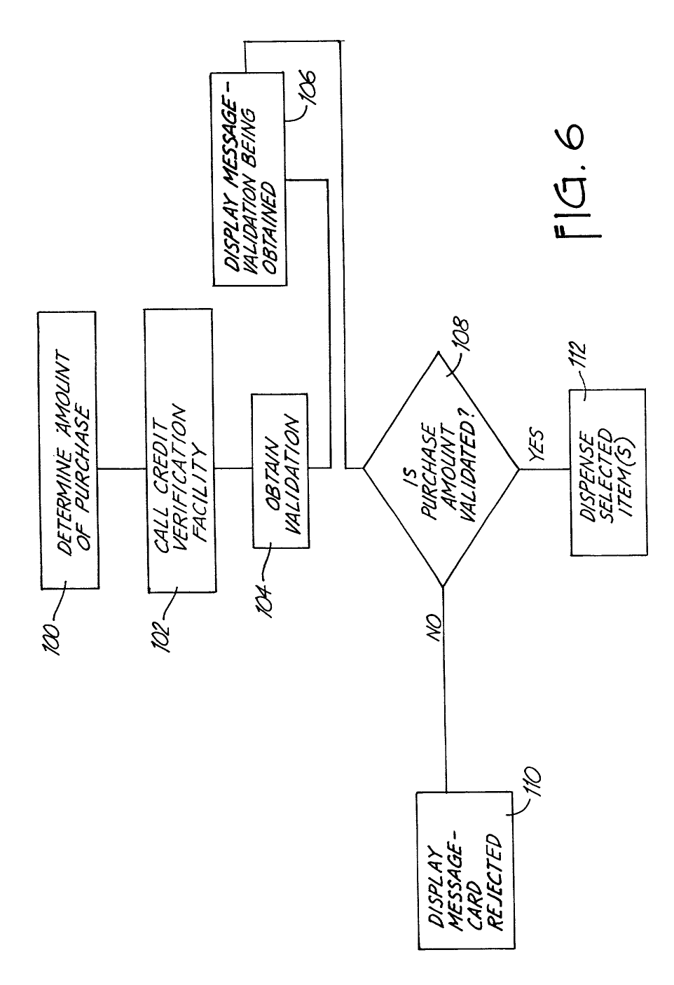

To dispense or vend a product 20, a vend mechanism 72 (FIGS. 2A, 5) comprising a motor 44 connected to each vend helix 18 via a set of gears is used. As more clearly shown in FIGS. 2A and 2B, a motor 44 is connected to a vend helix 18 via a driven gear 46. That is, for each dual helix 19 a motor 44 is connected to each vend helix 18 that forms a portion of the dual helix 19. A driven gear 46 is connected between the motor 44 and the vend helix 18. Between each of the two driven gears 46 are a pair of idler gears 48. That is, the driven gears 46 each have a vend motor 44 attached—one that rotates the vend helix clockwise and one that rotates the vend helix counterclockwise. The idler gears 48 ensure that the vend helixes 18 that form the dual helix 19 rotate synchronously. A standard motor used in vending machines may be used with the present invention.

Cushion Pad In Delivery Bin

A vending machine 10 shown in FIG. 1 is one embodiment in which large food products may be sold. Large food products are products that are approximately or greater than 16 ounces. In vending such products, care must be taken such that the food product is not damaged when it is dropped to the delivery bin 26. In one embodiment of the present invention, a cushioned pad 28 is placed on the floor of the delivery bin 26 so that the impact of the product 20 hitting the delivery bin does not damage the product 20. Moreover, the cushioned pad 28 also serves to protect the delivery bin 26 from being damaged. In one embodiment of the present invention, the cushioned pad 28 is formed by using foam rubber wrapped in a plastic sheet.

In operation, large products 20 may be placed in each compartment 42 of a vend tray 16 for purchase by customers. The customer pays for the product(s) 20 selected with cash, credit card, or debit card, and upon receiving the payment (or verification that the credit card account may be charged), the vending machine vends the product(s) 20 selected by the customer. The cushion pad 28 absorbs at least a portion of the impact when the selected product lands in the dispensing bin 26. The customer then removes the vended product from the dispensing bin 26.

Bag Dispenser

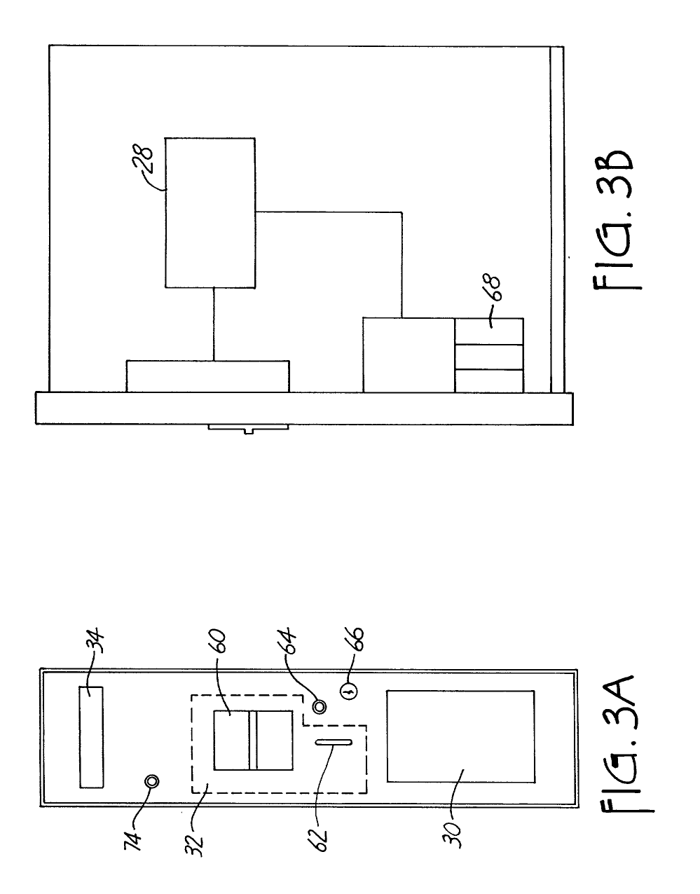

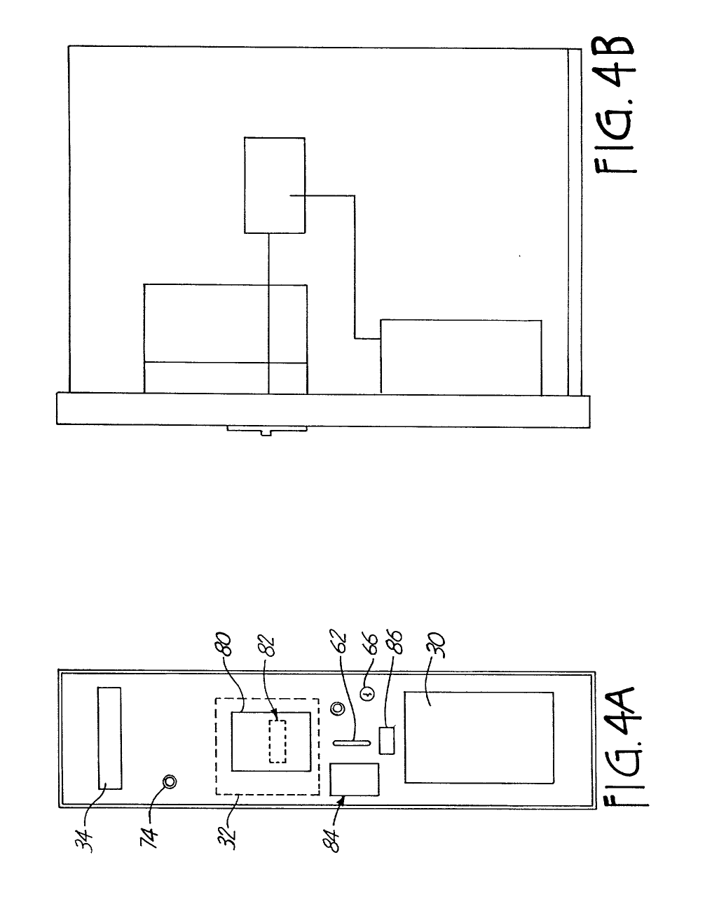

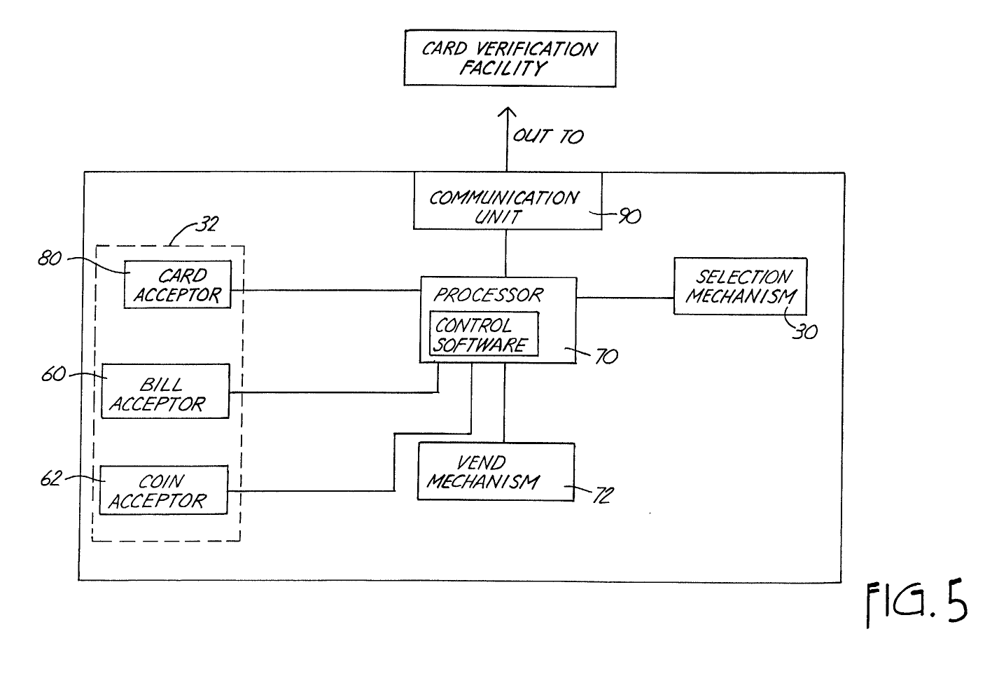

While not shown in FIG. 1, the vending machine 10 may include a bag dispenser for dispensing bags. In one embodiment (not shown), a box with bags for customer used are placed in a cashless vending machine. In a cashless vending machines, this bag box may be located where the coin tubes would be located in a machine with coin technology. See e.g., coin tubes 68 in FIG. 3B. A bag may be removed by the customer from a bag dispenser and used to carry product 20 purchased from the vending machine. The same type of coin return slot used on machines with coin technology may be used as the outlet for customers to access and take a bag. These coin return slots are well known in the art. See e.g., coin return slot 86 in FIG. 4A.

Storage Compartments

The vending machine shown in FIG. 1 also comprises a first storage compartment 22 and a second storage compartment 24 which may be used to store additional product 20 to be vended.

Refrigeration Unit

The vending machine 10 shown in FIG. 1 may be used to dispense large products that require refrigeration. In order to incorporate refrigeration technology into a vending machine, a refrigeration unit may be used. The use of a refrigeration unit is well-known to one of ordinary skill in the art. The vend trays 16 would be slidably attached to the interior of this refrigeration unit. Moreover, the storage compartments 22 and 24 may be formed within this refrigeration unit. Alternatively, the vending machine 10 would not have storage compartments 22 and 24 for storing additional product 20. Instead, all product 20 would be displayed. The refrigeration unit may have a temperature control that would allow dispensation of either frozen foods or foods that require refrigeration.

Microwave Units

The vending machine 10 shown in FIG. 8, may display and/or store frozen or otherwise microwavable food product 20 in either vend trays 16, storage compartments 22 and 24 or both. The embodiment shown in FIG. 8 shows the use of vend trays 16 for displaying food product 20. The vending machine 10 may also directly incorporate one or more microwave units 94 for heating the food product 20 upon purchase. These microwave units 94 may have a door accessible to the customer. These microwaves 94 may be traditional microwaves 94 which are set for a period of time selected by the customer. Or, the microwaves 94 may be pre-set to heat food placed into the microwaves 94 for an amount appropriate for the food product displayed in the vending machine. This microwave 94 may start upon the user closing the door or pushing a button. Alternatively, the microwave 94 may have a sensor that senses when food has been placed in the microwave 94 and the door has been closed. In this alternative embodiment, the microwave 94 starts once each of these two events has occurred.

As shown in FIG. 8, the vending machine may incorporate two microwaves 94 so that the vending machine may service two persons at one time that are waiting to purchase and consume microwavable food.

### Control Panel

With reference to FIGS. 1, 3A, 3B, 4A, 4B, 5, and 6, an embodiment of a control panel 14 will be described. As shown in FIG. 1, a control panel 14 may include a payment acceptor 32, a product selection mechanism 30, and a display 34, each of which may be operably connected to control circuitry 28.

Payment Mechanism

The vending machine 10 may be designed to accept more than one method of payment via the payment acceptor 32. The vending machine 10 may have a bill and/or coin payment acceptor 60, 62 (see FIGS. 3A and 3B) and/or a card payment acceptor 80 (see FIG. 4A).

Bill and Coin Payment Mechanism

With reference to FIGS. 3A and 3B, a payment acceptor 32 that comprises bill and coin money payment acceptors 60, 62 will be described. The bill acceptor 60 accepts dollar bills. FIG. 3A shows a front view of a control panel 14 that has a payment acceptor 32 which comprises a bill acceptor 60 and a coin acceptor 62. The control panel 14 also may include a display 34, a selection mechanism 30, a coin return button 64, a panel lock 66, and an indicator light 74. The bill acceptor 60 may be designed to accept one or more denominations of dollar bills. The bill acceptor 60 can detect the denomination of the dollar bill that it receives. Bill acceptor 60 is connected to control circuitry 28. In one embodiment, the bill acceptor 60 may be designed to accept $1, $5, and $10 bills. Also, the vending machine 10 may be designed with coin tubes 68 to provide the customer with change, if necessary. Bill acceptors 60 are well known in the art, and any bill acceptor 60 may be used with the vending machine of the present invention.

The coin acceptor 62 accepts coin money or, if desired, may accept any type of coin, including tokens. The coin acceptor 62 will determine the value of a deposited coin. The coin acceptor 62 is connected to the control circuitry 28. The coin acceptor may be designed to accept any coin. In one embodiment, the coin acceptor mechanism may accept nickels, dimes, and quarters. The coin acceptor also may have coins in tubes 68 for providing change to a customer. Coin payment mechanisms are well known for use with vending machines, and any such coin payment mechanism may be used with the present invention.

In operation, with respect to use of the bill and coin acceptors as the method of payment, the control circuitry 28 (along with any software used with the circuitry) receives a customer's payment information via the bill acceptor 60 or the coin acceptor 62. The control circuitry 28 also receives information from the selection mechanism 30 as to the customer's selection of items. If the customer pays an amount that covers the cost of the purchase, then the control circuitry 28 controls the vend mechanism 72 and causes the selected products 20 to be delivered.

Card Payment Mechanism

As shown in FIG. 4A, the payment acceptor 32 on the control panel 14 of the vending machine 10 may include a card acceptor 80. The card acceptor 80 may include a card reader 82 and a display. The card reader 82, of the card acceptor 80, may be a card reader 82 through which a customer swipes his/her payment card or may be a card reader 82 in which a customer inserts his/her payment card. In one embodiment, a payment card is one of a credit card, debit card, and store-valued card. Promotional store-valued cards set to an amount equal to an item vended by a given vending machine may be given to customers to encourage customers to try a free item from the vending machine. In operation, a customer may use a credit, debit or store-valued card to purchase items from the vending machine 10.

In order to implement a credit or debit card payment system with a vending machine 10, each vending machine 10 may be equipped with a communication unit 90 that communicates with a processor 70 and a remote credit verification facility to conduct the transaction. The processor 70 in conjunction with a communication unit 90 may verify and initiate fund collection from most major credit cards and debit cards, including, for example, Visa and MasterCard.

Also, each vending machine is equipped with a receipt printer 84 as part of the credit card system. This receipt printer 84 is legally required to be part of the credit card transaction. That is, the law requires the vending machine operator to provide a customer using a credit card with a receipt or to provide the customer with an opportunity to decline the receipt by pressing a button. Preferably, a thermal printer rather than a cutter printer is used for the required receipt, thus avoiding the frequent jamming associated with a cutter printer. The receipt printer 84 may be located on a credit verification module that also has the ability to print a receipt.

Selection Mechanism

The vending machine 10 includes a selection mechanism 30. This mechanism is used by a customer to select a product 20 for purchase. In one embodiment, the selection mechanism 30 may be a keypad. However, any selection mechanism 30 may be used to enable a user to select the product 20 to be purchased.

The selection mechanism 30 may also be used to enter a pin number in the event that a customer is charging a purchase to an ATM-type of debit card. Alternatively, a separate selection mechanism (not shown) may be used for the entrance of pin numbers for ATM cards. For example, if an adapted VeriFone Tranz 330 is used as a credit verification module, an attached PINpad 1000 available from Diebold may be attached for customer entry of pin numbers.

The processor 70 is adapted to receive information from the selection mechanism 30. In one embodiment, the user may be allowed to select more than one product 20 to be vended. The processor 70 may vend the selected product(s) 20 based on one payment transaction via a credit card, debit card, store-valued card and/or bill or coin money.

Display

The vending machine 10 also may have a display 34. The display may be any display device 34. In one embodiment, the display 34 is a color monitor. The processor 70 may inform the customer of the status of the purchase including informing the customer of when a credit card purchase is being verified by displaying this information on the display 34.

### Product Drop Sensor

The vending machine 10 may also include a product drop sensor (not shown) to inform a processor 70 that the product 20 was delivered. If the product 20 was not delivered, then the processor 70 may be programmed to not accept or authorize the payment, thus reducing the customer's fear of losing his/her payment. Moreover, with the product drop sensor, multiple vends for one payment may be accomplished. That is, the product drop sensor can determine if the number of products 20 selected have been vended.

### Communications Unit

Also, each vending machine 10 may be equipped with a communications unit 90. The communications unit 90 may be used to contact a credit verification facility to conduct card validation and to authorize payment of funds. Also, the communications unit 90 may be used to transmit reports on the status of the vending machine 10 from the processor 70 to the vending machine operator at all times. For example, the communications unit 90 may be used to automatically call the vending machine operator and report if the machine runs short of product 20 or has mechanical difficulties; i.e. the compressor stalls or quits or the temperature is not being maintained. In addition, this communications unit 90, if used in a vending machine 10 with a coin acceptor 62, may be used to let the vending machine operator know that additional change needs to be placed in the machine or that machine tampering is taking place. Further, the communications unit 90 may be used to transmit information regarding sales of particular products 20 and current inventories so that the vending machine operator may continuously re-design his or her stocking strategy.

Communication technology, such as a cellular modem, any other wireless communication system, and/or a landline communication system may be used. Preferably, a wireless communication system, such as the CDPD wireless communication technology offered by Cellgate, is used to transfer information between the vending machine 10 and a credit verification facility. In order that wireless technology in remote vending machines functions optimally, preferably, an antennae is attached to the back of the vending machine 10 to ensure a better signal for wireless communications.

CDPD technology may both receive and transmit data quickly and efficiently with minimal error. For example, the total transaction time using CDPD technology is approximately 4-6 seconds, from the time an amount to be validated is sent for verification to the time a product is vended. CDPD technology uses unused cellular channels (in the 800- to 900-MHZ range) to transmit and receive data in packets at a high speed and achieves quicker call set up than other communications technology and better error correction than modems or analog cellular channels. CDPD technology is well suited for short, periodic bursts of information, such as that needed for validation and authorization of payment collection from a credit card. CDPD technology is further well suited for use with vending machines because it is highly secure. CDPD technology is not only encrypted, but also involves channel hopping of the transmission. Further, CDPD technology will allow real-time processing to be less cost prohibitive because pricing plans are generally based on either low flat rates for the transmission of unlimited data or on file size of the data transmitted rather than the duration of the transmission.

As an alternative to or in addition to a wireless communications unit, a land-line telephone connection may also be used with the vending machine.

### Control Unit

FIG. 5 is a block diagram showing one embodiment of the control circuitry 28. As shown in FIG. 5, the control circuitry 28 comprises processor 70 operably connected to payment acceptor 32, which may include a bill acceptor 60, a coin acceptor 62, a card acceptor 80, and a selection mechanism 30. The processor 70 is also operably connected to vend mechanism 72 and a communication unit 90. The processor 70 may further comprise a credit verification module (not shown). Control circuitry that is manufactured by Coin Co. may be used for processing coin and bill dependent vending. An ACT A754 credit card acceptor may be used for multi-drop bus (MDB) vending, using, for example, a Diebold D5001 MDB Controller.

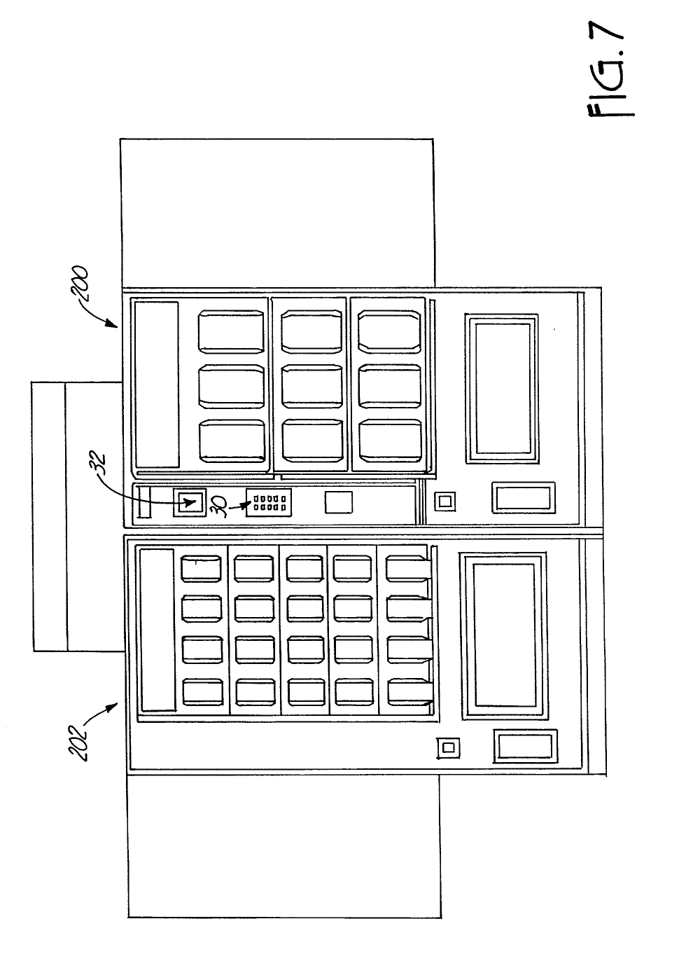

FIG. 6 is a flow chart that describes the acts performed by the processor 70 to enable the vending machine 10 to use a card payment mechanism in one embodiment of the present invention. Software operable by the processor 70 may be used to control performance of the acts involved in a card payment transaction. At block 100, a validation amount is determined. This amount may be determined in several ways. For example, the validation amount may be a preset amount. This preset amount may vary depending on whether the card is a credit card or debit card. Alternatively, the amount may be determined based on the total cost of one or more items selected for purchase by a customer. That is, the processor may receive the information relating to the product(s) 20 selected for purchase by a customer, calculate the total cost, confirm the total amount to be charged to the credit card, and then proceed with the acts to obtain validation.

At block 102, a credit verification facility is contacted. The control circuitry may make this call via wireless technology, such as CDPD technology, or via land lines. At block 104, validation that the card may be charged with the amount of the purchase is requested. During validation, a message may be displayed at block 106 informing the customer that validation that the credit card may be charged is being obtained. If validation is not given at block 108, then, at block 110, a message may be displayed or a receipt printed informing the customer that the card has been rejected. However, if validation is given, then at block 112, the product(s) 20 selected by the customer are dispensed. In one embodiment, the total transaction time is approximately or less than thirty (30) seconds, from the time an amount to be validated is sent for verification to the time a product is vended. In another embodiment, the total transaction time is approximately or less than fifteen (15) seconds, from the time an amount to be validated is sent for verification to the time a product is vended. In yet another embodiment, the total transaction time is approximately or less than ten (10) seconds, from the time an amount to be validated is sent for verification to the time a product is vended. In another embodiment, the total transaction time is approximately or less than six (6) seconds, from the time an amount to be validated is sent for verification to the time a product is vended.

In operation, with respect to use of a credit card as the method of payment, the processor 70 (along with any software operable on the processor 70) determines the amount to be charged to the credit card based on a preset amount of based on the purchases to be made. The processor 70 then interacts with the communications unit 90 to contact a credit verification facility to obtain validation. If validation is obtained, then one or more products 20 is selected (if not already selected before verification). As long as the amount of purchase, based on the product(s) 20 selected, is under or equal to the amount verified, the processor 70 interacts with a vend mechanism 72, such as the VMC Dispenser available from Diebold for dispensing the one or more selected product(s) 20. The customer then removes the vended product(s) 20 from a product delivery bin 26.

In one embodiment, the processor 70 comprises a controller and a credit verification module that interact to process the overall credit or debit card and vending transaction. For example, a Diebold D5001 MDB Controller may be used in conjunction with a credit verification module, such as an adapted Diebold VeriFone Tranz 330, along with software operable by each, in the present invention.

In such an embodiment, a customer may enter the desire to use a credit or ATM card on a selection pad and place his or her card into or through a card acceptor 80. The credit verification module in conjunction with the communications unit 90 attempts to validate the customer's account for the applicable amount. If validation is achieved, then the credit verification module may communicate the validated amount of credit to the controller. If validation is sought and achieved before selections are made, the controller may start a timer that runs a specified amount of time during which the customer may make selections and indicate when he or she is finished. After the customer indicates that no more selections are to be made, after any transaction limit has been reached, or after any time-out period has expired, whichever occurs first, the controller will communicate this information to the credit verification module. The credit verification module will then complete the transaction and queue the amounts to be collected for uploading to a credit verification facility. The processor 70 may then transmit the transaction information, such as amount charged or that any charge or debit was denied, to a receipt printer 84 to be printed for the customer. For example, the Verifone Tranz 330 has the ability to print and cut a receipt using an external printer, such as an Axiohm printer. The receipt printer 84 may also be used by the vending machine operator to print simple reports.

Preferably, real-time validation occurs with each transaction regardless of the amount of payment or whether the card has previously been used in the system. Final authorization of charge or debit to a card may be made at a specified time each day. Wireless technology, such as CDPD technology, makes it time and cost efficient to validate in real time with each transaction.

While several payment mechanisms have been described for use with a vending machine 10, the present invention contemplates vending machines 10 that use a credit or debit card payment system and quickly obtain real-time verification for each card use. Also, the present invention contemplates cashless vending machines that may vend more than one product 20 for one payment transaction. Cashless vending machines offer a number of advantages, including, a decreased need for security because money is not stored in the machine itself and decreased operator costs because the level of change in the machine does not have to be monitored and either collected or supplemented. Finally, any combination of payment systems may be implemented on a vending machine 10 of the present invention.

### Multiple Vending Machines Connected to One Control Unit

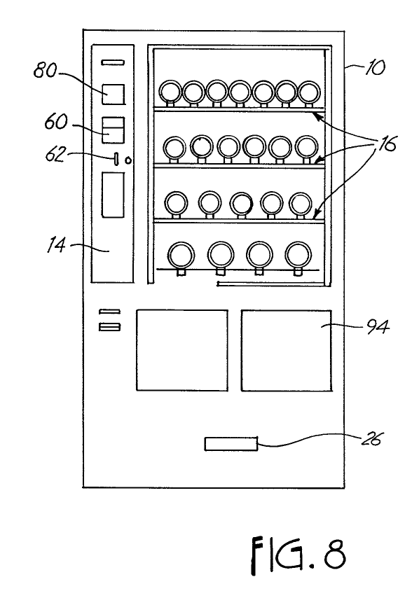

While the vending machine 10 may be a stand-alone machine, the card payment mechanism may be used on any configuration of a vending machine 10. One such embodiment is shown in FIG. 7. FIG. 7 shows two vending machines operably connected with one control unit 28. In particular, FIG. 7 shows a first vending machine 200 and a second vending machine 202. The first vending machine 200 may be called the “master,” and the second vending machine may be called the “add-on unit.” In a preferred embodiment, the master 200 has one payment acceptor 32, one selection mechanism 30, and one control unit 28. The payment acceptor 32 may include a bill and/or coin payment acceptor 60, 62 and a card payment acceptor 80. Similarly the selection mechanism 30 allows a customer to select items from both of the interconnected vending machines. The control unit 28 controls both vending machines. In this embodiment, the single control unit 28 controls (1) determining if payment for items selected from either or both machines has been made and/or authorized; and (2) dispensing of items selected from either or both vending machines.

In operation, vending machines of any type may be linked together. For instance, a two vending machine embodiment may be used to sell large family style dinners in one vending machine and sell small single serving dinners in the other vending machine. Another two vending machine embodiment may be used to sell dinner items (e.g., family style dinner entrees or single serving dinner entrees) in one vending machine with beverages being sold in the other vending machine. A further two vending machine embodiment may be used to sell a combination of food and non-food products, such as, food products in one vending machine and memorabilia, such as shirts and caps, in the other vending machine.

In another embodiment, the vending machine operator provides a microwave which is placed adjacent to the vending machines. The microwave selections may be pre-set to correspond to the product(s) 20 in the machine. For example, if one of the products 20 in a vending machine is lasagna, the microwave may have a selection that when chosen, is pre-set with the appropriate time and power level to cook lasagna. A microwave may be provided with single vending machine embodiments or with multiple vending machine embodiments.

A further embodiment of the present invention comprises one or more vending machines controlled by a terminal comprising a processor 70, a display 34 operably connected to the processor 70, and software operable on the processor 70. The software enables multiple vends from the two or more machines in exchange for one payment to cover the cost of all the products 20 vended. One embodiment of this terminal may be configured similar to an ATM machine used by banks.

Any general purpose or specialized processor 70 may be used with the present invention. The software operable on the processor 70 would enable a customer to purchase one or more products 20 from the two or more vending machines that are operably connected to the terminal. The terminal may accept credit or debit cards. Also, such a terminal may be configured to use stored-value cards. The terminal would have a communications unit 90, operable by the processor 70, to contact a credit/debit verification facility to authorize a charge to the account of the card used in the terminal.

The software may be configured to enable the display 34 to show pictures of the products 20 to be vended as well as any special deals being offered. Also, the program may be configured to include tracking of frequent purchasers, and to reward each of these frequent purchasers.

Also, modifications may be made remotely to the software. That is, prices for products 20 or other modifications may be made remotely to the terminal. The communications unit 90 may be used to load the software changes or a separate modem may be installed in the terminal for this purpose.

In operation, a customer may approach the terminal, and insert a card (e.g., a credit card or debit card) in a card reader or swipe a card through a card reader 82. The customer may then select one or more products 20 to purchase from the one or more vending machines connected to the terminal. The selections may be made via a selection mechanism 30, such as a touch screen on the display 34 or a separate keypad next to the display 34. After the selections are made, the processor 70 in conjunction with the communications unit 90 in the terminal initiates a call to a credit verification facility to obtain verification that the credit card or debit card may be charged with the amount of the purchase. If validation is received, then the selected product(s) 20 are vended. If validation is denied, the customer is notified that the validation is denied.

From the foregoing, it will be obvious to those skilled in the art that various modifications in the above described devices can be made without departing from the spirit and scope of the invention. Accordingly, the invention may be embodied in other specific forms without departint from the spirit or essential characteristics thereof. Present embodiments, therefore, are to be considered in all respects as illustrative and not restrictive, the scope of the invention being indicated by the appended claims rather than by the foregoing description, and all changes which come within the meaning and range of equivalency of the claims are therefore intended to be embraced therein.

We claim:

1. A vending machine, comprising:
a dispensing unit adapted to receive food items approximately or larger than 16 ounces;
control circuitry operably connected to the dispensing unit for dispensing one or more food items; and
a bag dispenser supported by the vending machine.

2. The vending machine of claim 1, further comprising a payment mechanism adapted to accept only cashless modes of payment for the food items.

3. The vending machine of claim 2, further comprising a card reader.

4. The vending machine of claim 2, further comprising a communications unit operably connected to the payment mechanism.

5. The vending machine of claim 4, wherein the communications unit enables communication via wireless technology.

6. The vending machine of claim 5, wherein the communications unit enables wireless communications via CDPD wireless technology.

7. The vending machine of claim 4, wherein the communications unit enables communications via telephone lines.

8. The vending machine of claim 4, further comprising a processor programmed to validate a payment card in real-time, each time a payment card is used in the vending machine.

9. The vending machine of claim 8, wherein a payment card comprises at least one of a credit card, a debit card, and a stored value card.

10. The vending machine of claim 8, wherein the validation is completed approximately or less than thirty (30) seconds.

11. The vending machine of claim 8, wherein the validation is completed approximately or less than fifteen (15) seconds.

12. The vending machine of claim 8, wherein the validation is completed in approximately or less than ten (10) seconds.

13. The vending machine of claim 8, wherein the validation is completed in approximately or less than six (6) seconds.

14. A vending machine, comprising:
a means for receiving and displaying food items approximately or larger than 16 ounces;
a means for dispensing one or more such food items; and
a means for dispensing bags through the vending machine.

15. The vending machine of claim 14, further comprising a means for storing bags to be dispensed by the bag dispensing means.

16. The vending machine of claim 15, further comprising a means for accepting cashless payments for food items.

17. The vending machine of claim 16, further comprising means for validating at least one of a credit card and a debit card.

18. The vending machine of claim 17, wherein the means for validating comprises a means for communicating from the vending machine to a remote facility.

19. The vending machine of claim 18, wherein the communication means includes a means for wireless communication from the vending machine.

20. The vending machine of claim 14, further comprising a means for accepting cash and cashless payments for food items to be dispensed by the vending machine.

21. A method for dispensing food items approximately or larger than 16 ounces via a vending machine, comprising:
receiving a payment for one or more food items;
dispensing one or more food items upon receipt of payment for the one or more food items; and
providing a bag dispenser for dispensing bags for use to carry the one or more dispensed food items.

22. The method of claim 21, wherein the act of receiving a payment comprises receiving cashless payments.

23. The method of claim 22, wherein the act of receiving a payment comprises receiving only cashless payments.

24. The method of claim 22, wherein the act of receiving cashless payments comprises accepting payment cards.

25. The method of claim 23, wherein the act of receiving cashless payments comprises accepting payment cards.

26. The method of claim 22, wherein the act of receiving a payment further comprises receiving cash payments.

27. The method of claim 24, wherein the act of receiving cashless payments via payment cards comprises accepting payments from at least one of a credit card, a debit card, and a stored value card.

28. The method of claim 23, wherein the act of receiving cashless payments via payment cards comprises accepting payments from at least one of a credit card, a debit card, and a stored value card.

29. The method of claim 24, further comprising validating in real-time the payment card each time a payment card is used to purchase one or more food items from the vending machine.

30. The method of claim 29, wherein the act of validating the payment card comprises completing the validation in approximately or less than thirty (30) seconds.

31. The method of claim 29, wherein the act of validating the payment card comprises completing the validation in approximately or less than fifteen (15) seconds.

32. The method of claim 29, wherein the act of validating the payment card comprises completing the validation in approximately or less than ten (10) seconds.

33. The method of claim 29, wherein the act of validating the payment card comprises completing the validation in approximately or less than six (6) seconds.

34. A vending machine, comprising a payment mechanism that accepts only cashless payments.

35. The vending machine of claim 34, wherein the payment mechanism comprises a card reader to read at least one of a credit card, a debit card, and a stored value card.

36. The vending machine of claim 35, wherein the payment mechanism comprises a processor for validating in real time at least one of a credit card and a debit card regardless of the amount of payment.

37. The vending machine of claim 36, further comprising a communications unit operably connected to the processor for communicating with a remote facility to validate the at least one of a credit card and a debit card.

38. The vending machine of claim 37, wherein the communications unit enables communication via wireless technology.

39. The vending machine of claim 38, wherein the communications unit enables wireless communications via CDPD technology.

40. The vending machine of claim 37, wherein the communications unit enables communications via telephone lines

41. The vending machine of claim 37, wherein the validation is completed in approximately or less than thirty (30) seconds.

42. The vending machine of claim 37, wherein the validation is completed in approximately or less than fifteen (15) seconds.

43. The vending machine of claim 37, wherein the validation is completed in approximately or less than ten (10) seconds.

44. The vending machine of claim 37, wherein the validation is completed in approximately or less than six (6) seconds.

45. The vending machine of claim 37, wherein the computer instructions operable by the processor for validating further comprises computer instructions for validating the at least one of a credit card and a debit card for a preset amount of money.

46. The vending machine of claim 45, wherein the computer instructions operable by the processor for validating the at least one of a credit card and a debit card for a preset amount of money comprises computer instructions that vary the preset amount based on whether the card to be validated is a credit card or a debit card.

47. A method of vending products using a vending machine comprising accepting only a cashless payment for one or more products.

48. The method of claim 47, wherein the act of accepting a cashless payment comprises accepting at least one of a credit card, a debit card, and a stored value card.

49. The method of claim 48, further comprises validating at least one of a credit card and a debit card.

50. The method of claim 49, wherein the act of validating comprises communicating with a remote facility.

51. The method of claim 50, wherein the act of validating comprises validating in real time each transaction regardless of the amount of payment.

52. The method of claim 50, wherein the act of validating comprises validating in real time each transaction regardless of whether the card has previously been used in the vending machine.

53. The method of claim 51, wherein the act of validating further comprises completing the validation in approximately or less than thirty (30) seconds.

54. The method of claim 51, wherein the act of validating further comprises completing the validation in approximately or less than fifteen (15) seconds.

55. The method of claim 51, wherein the act of validating further comprises completing the validation in approximately or less than ten (10) seconds.

56. The method of claim 51, wherein the act of validating further comprises completing the validation in approximately or less than six (6) seconds.

57. The method of claim 52, wherein the act of validating further comprises completing the validation in approximately or less than thirty (30) seconds.

58. The method of claim 52, wherein the act of validating further comprises completing the validation in approximately or less than fifteen (15) seconds.

59. The method of claim 52, wherein the act of validating further comprises completing the validation in approximately or less than ten (10) seconds.

60. The method of claim 52, wherein the act of validating further comprises completing the validation in approximately or less than six (6) seconds.

61. The method of claim 51, wherein at the act of communicating to the remote facility from the vending machine comprises using wireless technology.

62. The method of claim 61, wherein the act of using wireless technology further comprises using CDPD technology.

63. The method of claim 51, wherein the act of communicating to the remote facility from the vending machine comprises using telephone lines.

64. A vending machine, comprising a payment mechanism that accepts at least one of a credit card and a debit card, wherein the payment mechanism further comprises a processor with computer instructions operable by the processor for validating in real time each transaction made to purchase one or more products from the vending machine.

65. The vending machine of claim 64, wherein the computer instructions for validating further comprise computer instruction for validating each transaction regardless of the amount of the payment.

66. The vending machine of claim 64, wherein the computer instructions for validating further comprise computer instruction for validating each transaction regardless of whether the card has previously been used in the vending machine.

67. The vending machine of claim 64, wherein the computer instructions for validating further comprises instructions for validating for a preset amount.

68. The vending machine of claim 64, further comprising a communications unit operably connected to the processor for communicating with a remote facility.

69. The vending machine of claim 68, wherein the communications unit enables wireless communication from the vending machine.

70. The vending machine of claim 69, wherein the wireless communications unit comprises CDPD technology.

71. The vending machine of claim 68, wherein the communications unit enables communication over telephone lines.

72. The vending machine of claim 64, wherein the payment mechanism further accepts cash for products to be purchased from the vending machine.

73. A method of vending products from a vending machine, comprising:
accepting at least one of a credit card and a debit card for payment of one or more products to be purchased from the vending machine;
validating in real time each transaction of the at least one credit card and debit card used for payment.

74. The method of claim 73, wherein the act of validating comprises validating regardless of the amount of payment.

75. The method of claim 73, wherein the act of validating comprises validating regardless of whether the card had previously been used in the vending machine to purchase products.

76. The method of claim 73, wherein the act of validating comprises communicating with a remote facility.

77. The method of claim 76, wherein the act of communicating comprises communicating using wireless communication.

78. The method of claim 77, wherein the act of using wireless communication further comprises using CDPD technology.

79. The method of claim 76, wherein the act of communicating comprises using telephone lines.

80. The method of claim 76, wherein the act of validating comprises completing the validation in approximately or less than thirty (30) seconds.

81. The method of claim 76, wherein the act of validating comprises completing the validation in approximately or less than fifteen (15) seconds.

82. The method of claim 76, wherein the act of validating comprises completing the validation in approximately or less than ten (10) seconds.

83. The method of claim 76, wherein the act of validating comprises completing the validation in approximately or less than six (6) seconds.

84. A vending machine, comprising:
a first dispensing unit;
a second dispensing unit;
a control circuitry operably connecting the first and second dispensing units, wherein the control circuitry controls dispensing products in the first and second dispensing units; and
a payment mechanism operably connected to the first dispensing unit for receiving one payment for all products to be vended.

85. The vending machine of claim 84, wherein the first dispensing unit is adapted to vend non-beverage food products approximately or larger than sixteen (16) ounces.

86. The vending machine of claim 85, further comprises a payment mechanism that accepts at least one of a credit card and a debit card operably connected to the first dispensing unit for receiving one payment for all products to be vended.

87. The vending machine of claim 86, further comprising a communications unit, wherein the control circuitry and communications unit operate to obtain real-time validation for each card payment.

88. The vending machine of claim 87, wherein the communications unit comprises CDPD wireless technology.

89. A vending machine, comprising:
a first vending machine dispensing at least one family style dinner;
a second vending machine dispensing at least one single serving dinner; and
a control unit operably connected to the first and second vending machine, whereby the control unit controls dispensing items in the first and second vending machines.

90. A method for selling family style dinners and single serving dinners using vending machines, the method comprising:
providing a first vending machine stocked with at least one family style dinner, providing a second vending machine stocked with at least one single serving dinner; and
dispensing items selected from the first and second vending machines, whereby the dispensing is controlled by a control unit operably connected to the first and second vending machines.

91. The method for selling family style dinners and single serving dinners using vending machines of claim 90, further comprising:
providing a microwave adjacent to the vending machines, whereby the microwave selections are pre-set to correspond to the items in the machines.

92. A vending machine for dispensing packages approximately or greater than 16 ounces, comprising:
a housing,
at least one tray with at least one compartment for receiving an item approximately or greater than 16 ounces; and
a landing zone adapted to receive the item when dispensed from a compartment, wherein the landing zone includes a cushioned pad to protect the dispensed item.

93. The vending machine of claim 92, further comprising a bag dispenser for dispensing bags.

94. A vending machine, comprising:
a product dispensing unit,
a card payment acceptor,
a communications unit; and
a processor, wherein the processor and communications unit are adapted to cooperate to validate card payments in real-time each time a card is used in the machine.

95. A vending machine, comprising:
a product dispensing unit with a vend mechanism,
a payment acceptor; and
a processor operably connected to the vend mechanism and the payment acceptor, wherein the processor can vend multiple items based on a single payment.

96. A method of vending, comprising:
accepting selection of more than one item for purchase in a vending machine;
accepting payment for all selected items in one transaction; and
vending the selected items.

97. The method of claim 96, wherein the accepting payment includes accepting payment from a credit card.

98. The method of claim 96, wherein the act of accepting payment includes accepting payment from a debit card.

99. The method of claim 96, wherein the act of accepting payment includes accepting payment from bill money and coin money.

100. A vending machine, comprising:
a first dispensing unit,
a second dispensing unit,
a control unit operably connecting the first and second dispensing units; and
a cashless payment system operably connected to the first dispensing unit for receiving one payment for all products to be vended.

101. An apparatus for vending products, comprising:
two or more vending machines; and
a terminal that is connected to the two or more vending machines, wherein the terminal comprises a processor, and software operable on the processor for controlling the vending machines.

102. The apparatus of claim 101, further comprising a display on the terminal operably connected to the processor.

103. The apparatus of claim 101, wherein the terminal further comprises a payment acceptor.

104. The apparatus of claim 101, wherein the software enables at least two vends for each payment.

105. The apparatus of claim 102, further comprising a communications unit.

106. The apparatus of claim 102, wherein the payment acceptor is adapted to accept a payment card.

107. The apparatus of claim 102, wherein a payment card comprises at least one of a credit card, a debit card, and a store valued card.

108. A vending machine, comprising:
at least one microwave in the housing of a vending machine.

109. A method for vending, comprising:
providing at least one microwave in the housing of a vending machine.
